(19) United States
(12) Patent Application Publication
(10) Pub. No.: US 2025/0141605 A1
(43) Pub. Date: May 1, 2025

(54) NTN IOT HARQ DISABLING

(71) Applicant: Lenovo (Beijing) Limited, Beijing (CN)

(72) Inventors: Zhi Yan, Beijing (CN); Hongmei Liu, Beijing (CN); Yuantao Zhang, Beijing (CN); Yingying Li, Beijing (CN); Haiming Wang, Beijing (CN)

(73) Assignee: Lenovo (Beijing) Limited, Beijing (CN)

(21) Appl. No.: 18/723,245

(22) PCT Filed: Dec. 23, 2021
(86) PCT No.: PCT/CN2021/140767

§ 371 Date: Jun. 21, 2024

(51) Int. Cl. H04L 1/1829; H04L 1/1812

(52) U.S. Cl. CPC H04L 1/1854; H04L 1/1812

(57) ABSTRACT

Methods and apparatuses for are NTN IoT HARQ disabling disclosed. A UE comprises a processor; and a receiver coupled to the processor, wherein the processor is configured to receive, via the receiver, HARQ configuration and a control signal scheduling transport block(s), where each of the scheduled transport block(s) is associated with an HARQ process number; and receive, via the receiver, the scheduled transport block(s) based on the control signal.

### FIELD

The subject matter disclosed herein generally relates to wireless communications, and more particularly relates to methods and apparatuses for NTN (Non-Terrestrial Network) IoT (Internet of Things) HARQ (Hybrid Automatic Repeat request) disabling.

### BACKGROUND

The following abbreviations are herewith defined, at least some of which are referred to within the following description: New Radio (NR), Long Term Evolution (LTE), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field

Programmable Gate Array (FPGA), Orthogonal Frequency Division Multiplexing (OFDM), Radio Resource Control (RRC), User Entity/Equipment (Mobile Terminal), Transmitter (TX), Receiver (RX), Non-Terrestrial Network (NTN), Internet of Things (IoT), Narrow Band Internet of Things (NBIoT or NB-IoT), Physical Downlink Shared Channel (PDSCH), NBIoT Physical Downlink Shared Channel (NPDSCH), Physical Uplink Shared Channel (PUSCH), NBIoT

Physical Uplink Shared Channel (NPUSCH), Physical Downlink Control Channel (PDCCH), NBIoT Physical Control Channel (NPDCCH), Transport Block (TB), Automatic Repeat request (ARQ), Hybrid Automatic Repeat request (HARQ), Enhance Machine Type Communication (eMTC), Radio Link Control (RLC), Downlink Control Information (DCI), Frequency Division Duplex (FDD), Acknowledge (ACK), Cyclic Redundancy Check (CRC),

Radio Network Temporary Identity (RNTI), Cell RNTI (C-RNTI), Group RNIT (G-RNTI), Paging RNIT (P-RNTI).

A brief description of MPDSCH transmission is described as follows with reference to FIG. 1. A control signal (e.g. DCI) is transmitted in MPDCCH at for example subframe #0 scheduling multiple TBs (e.g. 8 TBs) transmitted in PDSCH, where each TB (each of D0 to D7) is transmitted in a separate subframe (i.e. from subframe #2 to subframe #9, suppose the scheduling delay, which means the delay from the reception of the DCI (e.g. M0) to the reception of the first TB (e.g. D0), is 2 subframes). Each scheduled TB is associated with a separate HARQ process number (e.g. from HARQ process #0 to HARQ process #7) in a corresponding HARQ process number increasing order. That is, D0 is associated with HARQ process #0; D1 is associated with HARQ process #1, . . . . For each TB (each of D0 to D7), an HARQ feedback (each of U0 to U7) is transmitted in PUCCH to indicate whether the PDSCH transmission in the TB is successfully received by the UE. As shown in FIG. 1, each of U0 to U7 indicates whether each of D0 to D7 is successfully received by the UE. U0 is associated with D0 because they are associated with the same HARQ process number (e.g. HARQ process #0).

The subframe at which the HARQ feedback is transmitted is determined as: for the PUCCH for corresponding TB_{b} start in subframe s_{b}, s₀=n₀+4, s_{b}=max{n_{b}+4, s_{b-1}+N_{b-1}}, b≈0, n_{b} is the last subframe in which the PDSCH containing TB b is transmitted, N_{b} denotes the number of consecutive subframes including non-BL/CE subframes where the PUCCH with HARQ-ACK for TB b is transmitted. As shown in FIG. 1, the HARQ feedbacks (U0 to U7) for the 8 PDSCH transmissions (D0 to D7) are transmitted in subframe #6 to subframe #13, respectively, in which s_{b}=n_{b}+4, b=0 to 7.

Different number of HARQ processes is supported in eMTC and NBIoT. For eMTC CE Mode A, 8 HARQ processes are supported. So, there are 8 HARQ process numbers (i.e. HARQ processes #0 to #7) in eMTC CE Mode A. For eMTC CE Mode B, 2 HARQ processes are supported; or 4 HARQ processes are supported if multiple TB scheduling is configured. For NBIoT, 2 HARQ processes (if configured) are supported.

Disabling of the HARQ feedback has been supported in NR NTN. In particular, enabling and disabling on HARQ feedback for downlink transmission (e.g. PDSCH transmission) can be at least configurable per HARQ process via UE specific RRC signalling. For example, UE can be configured by RRC parameter to enable or disable the HARQ feedback per HARQ process (i.e. per HARQ process number) via bitmap manner. As shown in FIG. 2, suppose that there are 8 HARQ processes (with HARQ process numbers #0 to #7), a bitmap with 8 bits can indicate HARQ feedback disabling or enabling of the 8 HARQ processes. For example, 0 indicates HARQ feedback disabling and 1 indicates HARQ feedback enabling.

When HARQ feedback disabling is configured for an HARQ process number, no explicit UL feedback for DL transmission acknowledges a successful transmission of a TB associated with a HARQ process having the HARQ process number. It means that the HARQ process number can be reused for a new DL transmission without waiting for the HARQ feedback. This can avoid HARQ stalling and consequently avoid throughput degradation. Correspondingly, retransmission at RLC layer (i.e. RLC ARQ) may be required to meet reliability requirements. Typically, ARQ re-transmissions in RLC layer can have high latency, which might be acceptable to IoT services (e.g. eMTC and NBIoT) since IoT services are generally delay tolerant.

If HARQ feedback disabling mechanism in NR NTN is introduced in IoT NTN (e.g. UE can be configured by RRC parameter to enable or disable the HARQ feedback per HARQ process via bitmap manner, and when multiple TBs are scheduled, the scheduled TBs are transmitted with corresponding HARQ process number increasing order), the TB(s) associated with HARQ process number with HARQ feedback enabled and the TB(s) associated with HARQ process number with HARQ feedback disabled may be transmitted in an interlaced manner.

For example, as shown in FIG. 3, HARQ processes #1, #3, #5 and #7 are configured with HARQ feedback disabled. Accordingly, the HARQ feedbacks U1, U3, U5 and U7 associated with HARQ processes #1, #3, #5 and #7 (i.e. HARQ feedbacks for D1, D3, D5 and D7) are not transmitted. On the other hand, HARQ processes #0, #2, #4 and #6 are configured with HARQ feedback enabled. Accordingly, the HARQ feedbacks U0, U2, U4 and U6 associated with HARQ processes #0, #2, #4 and #6 (i.e. HARQ feedbacks for DO, D2, D4 and D6) are transmitted. Although U1, U3 and U5 are not transmitted, since they are positioned among other used resources (e.g. U0, U2, U4 and U6), the base station tends to not use these UL resources. In other words, the PUCCH resources in U1, U3 and U5 are likely to be wasted, due to PUCCH non-continuous transmission. In addition, the last HARQ feedback is in subframe #12 (for transmission of U6). Compared with FIG. 1 in which HARQ feedback is not configured, the HARQ ACK feedback delay is only improved by one subframe (from subframe #13 to subframe #12), although four HARQ processes are configured with HARQ feedback disabled.

As a whole, it is not favorite to simply apply the NR NTN HARQ feedback disabling mechanism into IoT NTN.

HARQ feedback disabling also affects NPDCCH search space constraint. For max HARQ process number=2, the NPDCCH search space constraint is described as follows with reference to FIG. 4. If the NB-IoT UE detects NPDCCH with DCI Format N1 or N2 ending in subframe #n, and if an NPDSCH transmission starts from subframe #n+k, the UE is not required to monitor an NPDCCH candidate in any subframe starting from subframe #n+k−2 to subframe #n+k−1 (the UE is required to monitor an NPDCCH candidate in subframes from subframe #n+1 to #n+k−3); and if the NB-IoT UE detects NPDCCH with DCI Format N1 ending in subframe #n, and if the corresponding NPDSCH transmission starts from subframe #n+k, and for FDD, if the corresponding NPUSCH format 2 transmission starts from subframe #n+m, the UE is not required to monitor NPDCCH in any subframe starting from subframe #n+k to subframe #n+m−1.

As shown in FIG. 4, the HARQ delay (from the end of NPDSCH reception to the start of NPUSCH transmission) is more than 12 ms. The HARQ delay is for NPDSCH decoding, protocol process, DL/UL switch, UL data preparation, and UL scheduling flexibility.

FIG. 5 illustrates NPDCCH search space constraint in which there is no HARQ feedback (e.g. for paging and multicast scenarios).

If an NBIoT UE receives an NPDSCH transmission ending in subframe #n, and if the UE is not required to transmit a corresponding NPUSCH format 2, the UE is not required to monitor NPDCCH in any subframe starting from subframe #n+1 to subframe #n+12.

However, can the above-described NPDCCH search space constraint for the situation in which there is no HARQ feedback be applied to the situation in which HARQ feedback is disabled in unicast transmission?

This invention relates to enhancing the HARQ feedback disabling configuration for NTN IoT.

### BRIEF SUMMARY

Methods and apparatuses for NTN IoT HARQ disabling are disclosed.

In one embodiment, an UE comprises a processor; and a receiver coupled to the processor, wherein the processor is configured to receive, via the receiver, HARQ configuration and a control signal scheduling transport block(s), where each of the scheduled transport block(s) is associated with an HARQ process number; and receive, via the receiver, the scheduled transport block(s) based on the control signal.

In some embodiment, the processor is further configured to determine HARQ feedback for each of the scheduled transport block(s) based on the associated HARQ process number and the HARQ configuration.

In one embodiment, the HARQ configuration indicates the HARQ processes with HARQ feedback enabled or disabled via bitmap manner.

In another embodiment, the HARQ configuration indicates the number of HARQ processes with HARQ feedback enabled or the number of HARQ processes with HARQ feedback disabled. Accordingly, the processor is further configured to determine the HARQ processes with HARQ feedback enabled and with HARQ feedback disabled according to the number of HARQ processes with HARQ feedback enabled or the number of HARQ processes with HARQ feedback disabled.

In yet another embodiment, the processor is configured to receive, via the receiver, the scheduled transport block(s) with a transmission order determined by the HARQ process numbers and corresponding HARQ feedback enabled or disabled.

In a further embodiment, the association of the scheduled TB(s) and the HARQ process number(s) is determined by an indicated HARQ process number in the control signal and the corresponding HARQ processes with HARQ feedback enabled or disabled.

In some embodiment, the processor is further configured to terminate monitoring a search space for another control signal in a period after receiving the scheduled transport block(s), the period is determined by at least one of: the scheduled transport block(s) corresponding HARQ process with HARQ feedback enabled or disabled, the RNTI type associated with the control signal CRC scrambling, and the search space type associated with the control signal.

In one embodiment, a method at a UE comprises receiving HARQ configuration and a control signal scheduling transport block(s), where each of the scheduled transport block(s) is associated with an HARQ process number; and receiving the scheduled transport block(s) based on the control signal.

In another embodiment, a base unit comprises a processor; and a transmitter coupled to the processor, wherein the processor is configured to transmit, via the transmitter, HARQ configuration and a control signal scheduling transport block(s), where each of the scheduled transport block(s) is associated with an HARQ process number; and transmit, via the transmitter, the scheduled transport block(s) based on the control signal.

In yet another embodiment, a method at a base unit comprises transmitting HARQ configuration and a control signal scheduling transport block(s), where each of the scheduled transport block(s) is associated with an HARQ process number; and transmitting the scheduled transport block(s) based on the control signal.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates PDSCH transmission with multiple TB scheduled;

FIG. 2 illustrates NR NTN HARQ feedback disabling indication;

FIG. 3 illustrates HARQ feedback disabling mechanism in NR NTN introduced to IoT NTN;

FIG. 4 illustrates NPDCCH search space constraint;

FIG. 5 illustrates NPDCCH search space constraint in which there is no HARQ feedback (e.g. for paging and multicast scenarios);

FIG. 6 illustrates an example of configuring all of the HARQ processes with HARQ feedback disabled to the last of the scheduled TBs;

FIG. 7 illustrates an example of the first embodiment

FIG. 8 illustrates an example of the fourth embodiment;

FIG. 9 is a schematic flow chart diagram illustrating an embodiment of a method;

FIG. 10 is a schematic flow chart diagram illustrating another embodiment of a method; and

FIG. 11 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

In the description of the background part, FIG. 3 illustrates that if HARQ feedback disabling mechanism in NR NTN is simply introduced in IoT NTN, the TB(s) associated with HARQ process number with HARQ feedback enabled and the TB(s) associated with HARQ process number with HARQ feedback disabled may be transmitted in an interlaced manner, which is undesirable.

On the other hand, when multiple TBs are scheduled and the scheduled TBs are transmitted with corresponding HARQ process number increasing order, if all of the HARQ processes with HARQ feedback disabled are configured to the last of the scheduled TBs, the wasted resource due to non-continuous transmission can be saved. In addition, the HARQ ACK feedback delay can be minimized.

An example of the corresponding HARQ process number increasing order is described as follows. It is assumed a maximal of 8 HARQ processes (e.g. HARQ process numbers of 0 to 7) are supported. Four TBs (e.g. TB1, TB2, TB3 and TB4) are scheduled by a DCI. HARQ process numbers 2, 3, 5 and 7 are assigned by a binomial coefficient value indicated in the DCI. Accordingly, TB1 is associated with HARQ process #2; TB2 is associated with HARQ process #3; TB3 is associated with HARQ process #5; and TB4 is associated with HARQ process #7. Therefore, the four TBs are transmitted with corresponding HARQ process number increasing order (i.e. an order of 2, 3, 5, 7), that is, in an order of TB1, TB2, TB3 and TB4.

FIG. 6 illustrates an example of configuring all of the HARQ processes with HARQ feedback disabled to the last of the scheduled TBs. As shown in FIG. 6, a control signal (e.g. DCI) is transmitted in MPDCCH at subframe #0 scheduling 8 TBs transmitted in PDSCH, where each scheduled TB is associated with a separate HARQ process number (e.g. from HARQ process #0 to HARQ process #7) in a corresponding HARQ process number increasing order. HARQ processes #0, #1, #2 and #3 are configured with HARQ feedback enabled, while HARQ processes #4, #5, #6 and #7 are configured with HARQ feedback disabled (i.e. associated with the last of the scheduled TBs (D4, D5, D6 and D7). Accordingly, U0, U1, U2 and U3 for HARQ processes #0, #1, #2 and #3 (i.e. HARQ feedbacks for D0, D1, D2 and D3) are transmitted without repetition (e.g., repetition number of 1), while U4, U5, U6 and U7 for HARQ processes #4, #5, #6 and #7 (i.e. HARQ feedbacks for D4, D5, D6 and D7) are not transmitted. Compared with the example shown in FIG. 3, it can be seen that, in the example of FIG. 6, unused UL resources U4, U5, U6 and U7, which are not interlaced, can be used by the base station without waste. In addition, since all HARQ feedbacks (e.g. U0, U1, U2 and U3) are transmitted without interval so that the last HARQ ACK feedback is in subframe #9 (for transmission of U3), the HARQ ACK feedback delay can be improved in a maximal manner.

As a whole, it is favorable that the HARQ process(es) with HARQ feedback

disabled are configured in the last of the scheduled TBs.

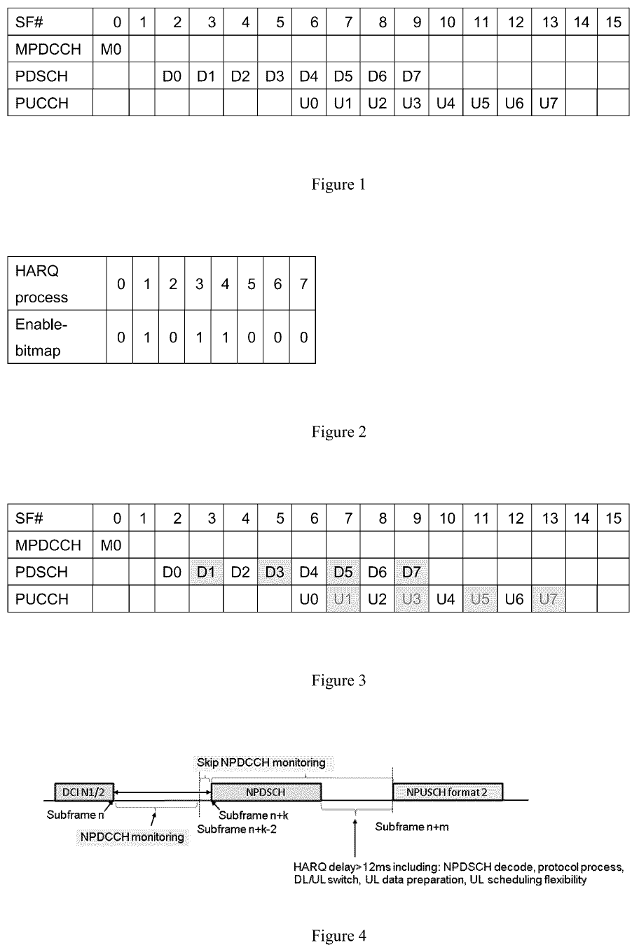

According to a first embodiment, the UE is configured by RRC parameter (e.g. “harq-enabling-disabling”) to enable or disable the HARQ feedback per HARQ process via bitmap manner, e.g. in the manner described with reference to FIG. 2. It is up to the base station to configure the HARQ process(es) with HARQ feedback disabled in the last of the scheduled TBs (i.e. in the last of the HARQ process numbers).

FIG. 7 illustrates an example of the first embodiment. A control signal (e.g. DCI) is transmitted in MPDCCH at subframe #0 scheduling 8 TBs transmitted in PDSCH, where each scheduled TB is sequentially associated with a separate HARQ process number (e.g. from HARQ process #0 to HARQ process #7). According to the first embodiment, the base station can only configure one or more HARQ processes that are in the last to HARQ feedback disabled. In the example of FIG. 7, only the last three HARQ processes (with HARQ process numbers 5, 6 and 7) are configured to HARQ feedback disabled.

The drawback of the first embodiment is that restrictions are made to the scheduling. That is, the base station cannot arbitrarily configure HARQ processes to HARQ feedback disabled. According to the first embodiment, only the last one or more HARQ processes can be configured to HARQ feedback disabled.

According to a second embodiment, the UE is configured by RRC parameter to indicate the number of HARQ processes with HARQ feedback enabled or the number of HARQ processes with HARQ feedback disabled. The HARQ process(es) with HARQ feedback enabled and the HARQ process(es) with HARQ feedback disabled can be derived from the number of HARQ processes with HARQ feedback enabled or the number of HARQ processes with HARQ feedback disabled.

If the number of HARQ processes with HARQ feedback enabled is configured, the HARQ processes with HARQ feedback enabled are of the number of HARQ processes with HARQ feedback enabled, and begin from HARQ process with the lowest number (e.g. HARQ process #0); and the HARQ processes with HARQ feedback disabled are of the total number of HARQ processes minus the number of HARQ processes with HARQ feedback enabled, and begin from the next number of the HARQ process number of the last HARQ process with HARQ feedback enabled.

For example, the UE can configured with the number of HARQ processes with HARQ feedback enabled, e.g. N0. Suppose that the total number of HARQ processes is N (e.g.

the HARQ process number can be 0, 1, . . . , N−1), the HARQ processes with HARQ feedback enabled are {HARQ process #0, HARQ process #1, . . . , HARQ process #N0−1}, while the HARQ processes with HARQ feedback disabled are {HARQ process #N0, HARQ process #N0+1, . . . , HARQ process #N−1}. In particular, if N=8 and N0=3, then the HARQ processes with HARQ feedback enabled are {HARQ process #0, HARQ process #1, HARQ process #2}, and the HARQ processes with HARQ feedback disabled are {HARQ process #3, HARQ process #4, HARQ process #5, HARQ process #6, HARQ process #7}.

If the number of HARQ processes with HARQ feedback disabled is configured, the HARQ processes with HARQ feedback enabled are of the number of the total number of HARQ processes minus the number of HARQ processes with HARQ feedback disabled, and begin from HARQ process with the lowest number (e.g. HARQ process #0); and the HARQ processes with HARQ feedback disabled are of the number of HARQ processes with HARQ feedback disabled, and begin from the next number of the HARQ process number of the last HARQ process with HARQ feedback enabled.

For another example, the UE is configured with the number of HARQ processes with HARQ feedback disabled, e.g. N1. Suppose that the total number of HARQ processes is N (e.g. the HARQ process number can be 0, 1, . . . , N−1), the HARQ processes with HARQ feedback enabled are {HARQ process #0, HARQ process #1, . . . , HARQ process #N-N1−1}, while the HARQ processes with HARQ feedback disabled are {HARQ process #N-N1, HARQ process #N-N1+1, . . . , HARQ process #N−1}. In particular, if N=8 and N1=3, then the HARQ processes with HARQ feedback enabled are {HARQ process #0, HARQ process #1, HARQ process #2, HARQ process #3, HARQ process #4}, and the HARQ processes with HARQ feedback disabled are {HARQ process #5, HARQ process #6, HARQ process #7}.

According to a third embodiment, the UE is configured by RRC parameter to enable or disable the HARQ feedback per HARQ process (i.e. per HARQ process number) via bitmap manner. In addition, the scheduled TBs are transmitted with a reordered sequence (i.e. an order different from the traditional order), where the reordered sequence is based on corresponding HARQ processes with HARQ feedback enabled or disabled and the HARQ process numbers, and in particular, based on corresponding HARQ processes with HARQ feedback enabled prior to disabled with HARQ process number increasing. Note that corresponding HARQ processes mean HARQ processes corresponding to TBs.

For example, suppose, for a total of 4 HARQ process numbers (e.g. 0 to 3), the HARQ processes with HARQ feedback enabled or disabled are configured as {disabled, enabled, disabled, enabled}. That is, {HARQ process #0 with HARQ feedback disabled, HARQ process #1 with HARQ feedback enabled, HARQ process #2 with HARQ feedback disabled, HARQ process #3 with HARQ feedback enabled}. The base station schedules 3 TBs (e.g. TB0, TB1 and TB3) with HARQ processes #0, #1 and #3 (Note that HARQ process #2 is not used). The scheduled TBs are associated with HARQ process numbers in an increasing order: TB0, TB1 and TB3 are associated with HARQ process #0, HARQ process #1 and HARQ process #3, respectively.

Traditionally, the scheduled TBs are transmitted sequentially. That is, BL/CE DL subframes n_{r·N+l} with l=0, 1, . . . N−1 are associated with TBᵣ₊₁, r=0, 1, . . . N_{TB}−1, where N is repetition number of each TB, N_{TB} is the number of scheduled TBs. BL/CE DL subframes n_{r·N+l} is available downlink subframe with subframe index of r·N+l for eMTC. For example, the scheduled 3 TBs are transmitted sequentially with an increasing order of the HARQ process numbers, i.e. an order of {TB0, TB1 and TB3}, which is the increasing order of the HARQ process numbers: HARQ process #0, HARQ process #1 and HARQ process #3.

According to the third embodiment, the scheduled 3 TBs (TB0, TB1 and TB3) are transmitted with a reordered sequence, wherein the reordered sequence is based on corresponding HARQ processes with HARQ feedback enabled or disabled (e.g. {disabled, enabled, disabled, enabled}) and the HARQ process numbers (e.g. 0, 1 and 3), e.g. based on corresponding HARQ processes with HARQ feedback enabled prior to disabled with HARQ process number increasing, i.e. {TB1, TB3, TB0}. That is, the corresponding HARQ processes with HARQ feedback enabled (in this example: TB1 and TB3 in HARQ process number increasing order) are transmitted prior to the corresponding HARQ processes with HARQ feedback disabled (in this example, TB0; note that HARQ process #2 is not used in this example).

That is, TB1 and TB3, that belong to HARQ processes with HARQ feedback enabled, are transmitted prior to TB0, that belongs to HARQ processes with HARQ feedback disabled; and within TB1 and TB3, TB1 is transmitted prior to TB3 based on HARQ process number increasing order.

According to the third embodiment, the scheduled TBs are transmitted with a reordered sequence. That is, BL/CE DL subframes n_{r·N+l} with l=0, 1, . . . N−1 are associated with TB_{ƒ(r)+1}, ƒ(r) is the function of reordering index of TBᵣ with order of TB corresponding HARQ process with feedback enabled and disabled with HARQ process number increasing sequentially, r=0, 1, . . . N_{TB}−1, where N is repetition number of each TB, N_{TB} is the number of scheduled TBs.

According to the third embodiment, the TBs corresponding to the HARQ processes with HARQ feedback disabled are definitely transmitted in the last of the scheduled TBs.

According to a fourth embodiment, the UE is configured by RRC parameter to enable or disable the HARQ feedback per HARQ process (i.e. per HARQ process number) via bitmap manner. In addition, the association of the scheduled TBs with HARQ process numbers is reordered. The association between TBs and HARQ process numbers can be determined based on DCI indication and corresponding HARQ processes with HARQ feedback enabled or disabled, and in particular, TBs in DCI scheduled increasing number are associated with the HARQ process numbers with HARQ feedback enabled prior to disabled with HARQ process number increasing.

For example, suppose, for a total of 4 HARQ process numbers (e.g. 0 to 3), the HARQ processes with HARQ feedback enabled or disabled are configured as {disabled, enabled, disabled, enabled}. The base station uses a DCI to schedule 3 TBs (e.g. TB0, TB1 and TB3) with HARQ processes #0, #1 and #3. The scheduled 3 TBs (TB0, TB1 and TB3) are transmitted sequentially (which is the same as prior art) with an order of {TB0, TB1 and TB3}.

Traditionally, for a BL/CE UE, if the UE is configured with multiple TBs transmission, the HARQ process ID hi for each of the scheduled TBs TB+1is determined from a combinatorial index indicated in the DCI (e.g., a binomial coefficient value). For example, 3 scheduled TBs are associated with three HARQ processes (e.g. HARQ processes #0, #1 and #3 determined from the combinatorial index) sequentially, that is, {TB0 with HARQ process #0, TB1 with HARQ process #1, and TB3 with HARQ process #3}.

On the other hand, according to the fourth embodiment, the association between the scheduled TBs (TB0, TB1 and TB3) and the HARQ processes #0, #1 and #3 determined based on DCI indication (i.e. TB0, TB1 and TB3 are scheduled) and corresponding HARQ processes with HARQ feedback enabled or disabled (i.e. {disabled, enabled, disabled, enabled}). In particular, TBs in DCI scheduled increasing number (i.e. TB0, TB1 and TB3) are associated with the HARQ process numbers with HARQ feedback enabled (HARQ process #1 and HARQ process #3 in HARQ process number increasing order) prior to associated with the HARQ process numbers with HARQ feedback disabled (HARQ process #0; note that HARQ process #2 is not used in this example). That is, the association between TBs and HARQ process numbers according to the second sub-embodiment of the third embodiment is {TB0 with HARQ process #1, TB1 with HARQ process #3, and TB3 with HARQ process #0}.

According to the fourth embodiment, the association of the scheduled TBs with HARQ process numbers is reordered. That is, for a BL/CE UE, if the UE is configured with multiple TBs transmission, the HARQ process IDH={h₀, h₁ . . . h_{N}_{_{TB}}₋₁} for scheduled TBs {TB₁, TB₂ . . . TB_{N}_{_{TB}}} is the reordering of {h′₀, h′₁ . . . h′_{N}_{_{TB}}₋₁} with HARQ process with HARQ feedback enabled and disabled and HARQ process number increasing, where h′ᵢ (i=0, 1, . . . , N_{TB}−1) is determined from a combinatorial index indicated in the DCI (e.g., a binomial coefficient value).

According to the fourth embodiment, the TBs corresponding to the HARQ processes with HARQ feedback disabled are also definitely transmitted in the last of the scheduled TBs.

A fifth embodiment relates to the NPDCCH search space constraint in IoT NTN with HARQ feedback disabling.

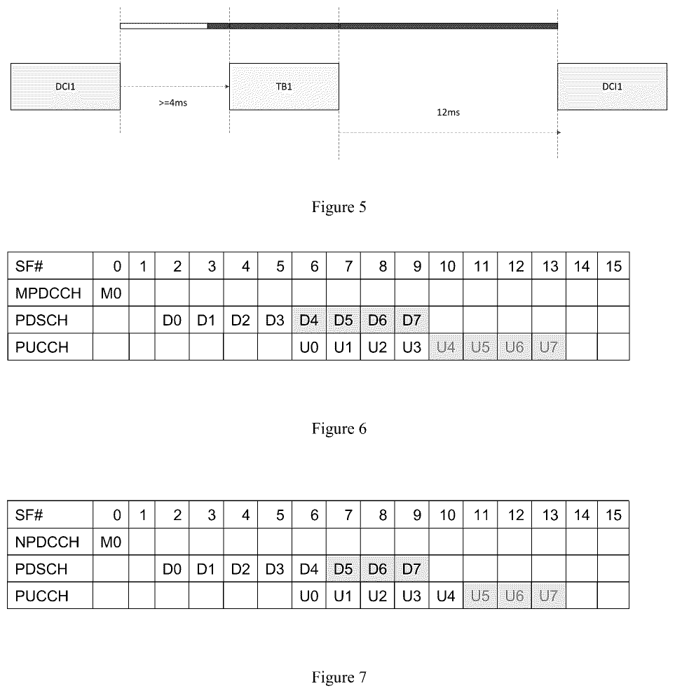

If the legacy NPDCCH search space constraint for paging and multicast in which there is no HARQ feedback (as shown in FIG. 5) is used in IoT NTN with HARQ feedback disabling, the HARQ delay (from the end of reception of TB1 to the monitoring of next DCI1) is at least 12 ms. The HARQ delay is for NPDSCH decoding, protocol process, new monitoring carriers switch, etc. It means that, if an NBIoT UE receives an NPDSCH transmission ending in subframe #n, and if the UE is not required to transmit a corresponding NPUSCH format 2, the UE is not required to monitor NPDCCH in any subframe starting from subframe #n+1 to subframe #n+12.

However, the 12 ms NPDCCH monitoring termination is too long for unicast case if peak data rate is the goal to be improved. The NPDSCH decoding time is smaller than 8 ms (e.g., 4 ms). In addition, in unicast, the same UE-specific search space is monitored, which saves time. In particular, in unicast transmission, UE shall continue monitoring UE-specific search space for another new DCI (e.g. DCI2) if a DCI (e.g. DCI1) is detected with corresponding HARQ process with HARQ feedback disabled (when supported HARQ process number is 2). Moreover, the demodulation of NPDCCH and the decoding of NPDSCH can be made simultaneously if HARQ process number is 2. As a whole, when HARQ feedback is configured in unicast, it is not favourite to follow the legacy NPDCCH search space constraint for paging and multicast.

According to the fourth embodiment, the UE terminates monitoring NPDCCH in a period determined by the corresponding NPDSCH HARQ process with HARQ feedback enabled or disabled, or by the search space type (e.g., common search space or UE-specific search space), or by the corresponding DCI with CRC scrambled RNTI (e.g., by C-RNTI or G-RNTI or P-RNTI).

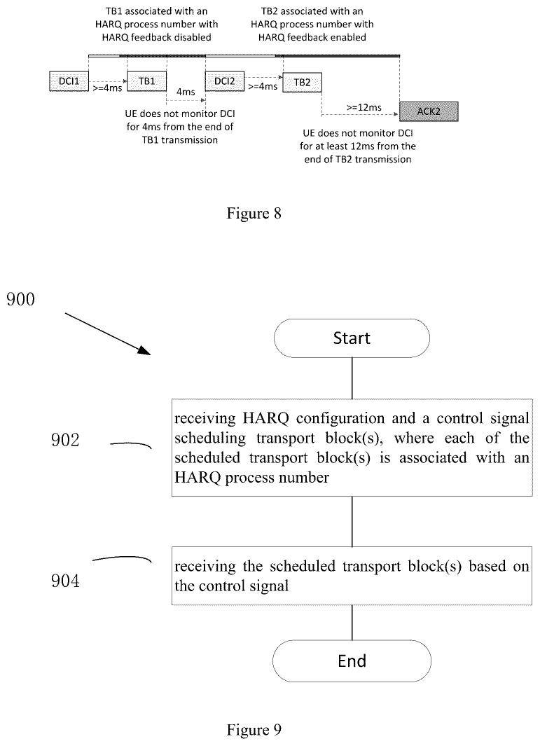

FIG. 8 illustrates an example of the fourth embodiment.

For example, if an NBIoT UE receives an NPDSCH transmission (e.g. TB1) ending in subframe #n and if the UE is not required to transmit a corresponding NPUSCH format 2, if HARQ process corresponding to TB1 is configured by RRC parameter “harq-enabling-disabling” as “HARQ feedback disabled”, the UE is not required to monitor NPDCCH in any subframe starting from subframe #n+1 to subframe #n+4 or #n+8; Otherwise (if it is paging and multicast), the UE is not required to monitor NPDCCH in any subframe starting from subframe #n+1 to subframe #n+12.

For another example, if an NBIoT UE receives an NPDSCH transmission (e.g. TB1) (scheduled by a DCI transmitted in NPDCCH) ending in subframe #n, the UE is not required to transmit a corresponding NPUSCH format 2, and the NPDCCH is associated with CRC scrambled by C-RNTI or G-RNTI, the UE is not required to monitor NPDCCH in any subframe starting from subframe #n+1 to subframe #n+4 or #n+8; Otherwise (if it is paging and multicast (e.g. the NPDCCH is associated with CRC scrambled by P-RNTI)), the UE is not required to monitor NPDCCH in any subframe starting from subframe #n+1 to subframe #n+12.

For yet another example, if an NBIoT UE receives an NPDSCH transmission (e.g. TB1) (scheduled by a DCI transmitted in NPDCCH) ending in subframe #n and if the UE is not required to transmit a corresponding NPUSCH format 2, if the NPDCCH associated DCI is in UE-specific search space, the UE is not required to monitor NPDCCH in any subframe starting from subframe #n+1 to subframe #n+4 or #n+8; Otherwise (if it is paging and multicast (e.g. the

NPDCCH associated DCI is in common search space)), the UE is not required to monitor NPDCCH in any subframe starting from subframe #n+1 to subframe #n+12.

If the UE receive an NPDSCH ending in subframe #n with HARQ process with HARQ feedback disabled, the UE is not expected to receive an NPDCCH with DCI format N1 for the same HARQ process ID in any subframe starting from subframe #n+1 to subframe #n+12.

In the example of FIG. 8, an NBIoT UE receives an NPDSCH transmission TB1 associated with an HARQ process number with HARQ feedback disabled (scheduled by DCI1). The UE will not monitor control signal for 4 ms starting from the end of TB1 transmission in NPDSCH. That is, the UE (re)starts monitoring control signal 4 ms after the end of TB1 transmission in NPDSCH. In addition, the UE also receives an NPDSCH transmission TB2 associated with an HARQ process number with HARQ feedback enabled (scheduled by DCI2). The UE will not monitor control signal from the end of TB2 transmission in NPDSCH to the start of NPUSCH format 2 transmission, that is at least 12 ms.

FIG. 9 is a schematic flow chart diagram illustrating an embodiment of a method 900 according to the present application. In some embodiments, the method 900 is performed by an apparatus, such as a remote unit (UE). In certain embodiments, the method 900 may be performed by a processor executing program code, for example, a microcontroller, a microprocessor, a CPU, a GPU, an auxiliary processing unit, a FPGA, or the like.

The method 900 may comprise 902 receiving HARQ configuration and a control signal scheduling transport block(s), where each of the scheduled transport block(s) is associated with an HARQ process number; and 904 receiving the scheduled transport block(s) based on the control signal.

In some embodiment, the method further comprises determining HARQ feedback for each of the scheduled transport block(s) based on the associated HARQ process number and the HARQ configuration.

In one embodiment, the HARQ configuration indicates the HARQ processes with HARQ feedback enabled or disabled via bitmap manner.

In another embodiment, the HARQ configuration indicates the number of HARQ processes with HARQ feedback enabled or the number of HARQ processes with HARQ feedback disabled. Accordingly, the method may further comprise determining the HARQ processes with HARQ feedback enabled and with HARQ feedback disabled according to the number of HARQ processes with HARQ feedback enabled or the number of HARQ processes with HARQ feedback disabled.

In yet another embodiment, the scheduled transport block(s) are received with a transmission order determined by the HARQ process numbers and corresponding HARQ feedback enabled or disabled.

In a further embodiment, the association of the scheduled TB(s) and the HARQ process number(s) is determined by an indicated HARQ process number in the control signal and the corresponding HARQ processes with HARQ feedback enabled or disabled.

In some embodiment, the method may further comprise terminating monitoring a search space for another control signal in a period after receiving the scheduled transport block(s), the period is determined by at least one of: the scheduled transport block(s) corresponding HARQ process with HARQ feedback enabled or disabled, the RNTI type associated with the control signal CRC scrambling, and the search space type associated with the control signal.

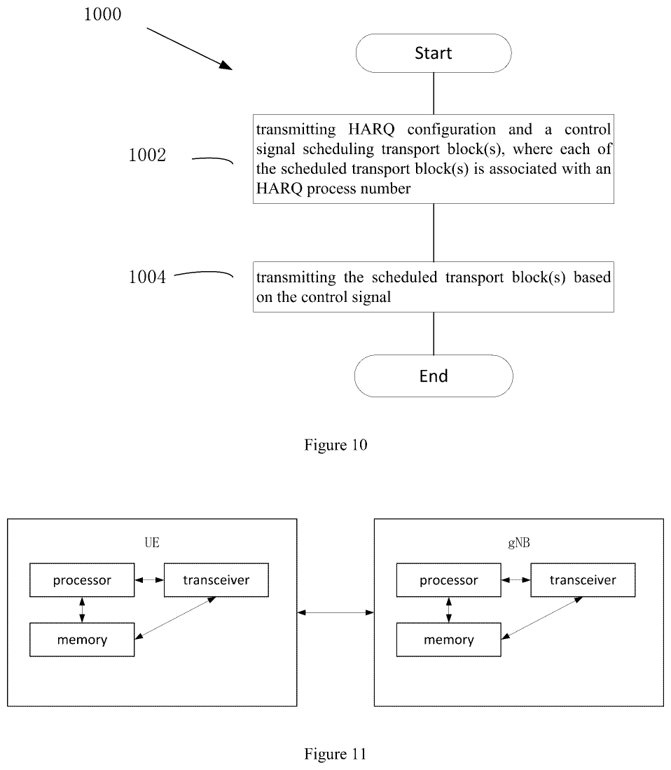

FIG. 10 is a schematic flow chart diagram illustrating a further embodiment of a method 1000 according to the present application. In some embodiments, the method 1000 is performed by an apparatus, such as a base unit. In certain embodiments, the method 1000 may be performed by a processor executing program code, for example, a microcontroller, a microprocessor, a CPU, a GPU, an auxiliary processing unit, a FPGA, or the like.

The method 1000 may comprise 1002 transmitting HARQ configuration and a control signal scheduling transport block(s), where each of the scheduled transport block(s) is associated with an HARQ process number; and 1004 transmitting the scheduled transport block(s) based on the control signal.

In some embodiment, the method further comprises determining HARQ feedback for each of the scheduled transport block(s) based on the associated HARQ process number and the HARQ configuration.

In one embodiment, the HARQ configuration indicates the HARQ processes with HARQ feedback enabled or disabled via bitmap manner.

In another embodiment, the HARQ configuration indicates the number of HARQ processes with HARQ feedback enabled or the number of HARQ processes with HARQ feedback disabled. Accordingly, the method may further comprise determining the HARQ processes with HARQ feedback enabled and with HARQ feedback disabled according to the number of HARQ processes with HARQ feedback enabled or the number of HARQ processes with HARQ feedback disabled.

In yet another embodiment, the scheduled transport block(s) are transmitted with a transmission order determined by the HARQ process numbers and corresponding HARQ feedback enabled or disabled.

In a further embodiment, the association of the scheduled TB(s) and the HARQ process number(s) is determined by an indicated HARQ process number in the control signal and the corresponding HARQ processes with HARQ feedback enabled or disabled.

FIG. 11 is a schematic block diagram illustrating apparatuses according to one embodiment.

Referring to FIG. 11, the UE (i.e. the remote unit) includes a processor, a memory, and a transceiver. The processor implements a function, a process, and/or a method which are proposed in FIG. 9.

The UE comprises a processor; and a receiver coupled to the processor, wherein the processor is configured to receive, via the receiver, HARQ configuration and a control signal scheduling transport block(s), where each of the scheduled transport block(s) is associated with an HARQ process number; and receive, via the receiver, the scheduled transport block(s) based on the control signal.

In some embodiment, the processor is further configured to determine HARQ feedback for each of the scheduled transport block(s) based on the associated HARQ process number and the HARQ configuration.

In one embodiment, the HARQ configuration indicates the HARQ processes with HARQ feedback enabled or disabled via bitmap manner.

In another embodiment, the HARQ configuration indicates the number of HARQ processes with HARQ feedback enabled or the number of HARQ processes with HARQ feedback disabled. Accordingly, the processor is further configured to determine the HARQ processes with HARQ feedback enabled and with HARQ feedback disabled according to the number of HARQ processes with HARQ feedback enabled or the number of HARQ processes with HARQ feedback disabled.

In yet another embodiment, the processor is configured to receive, via the receiver, the scheduled transport block(s) with a transmission order determined by the HARQ process numbers and corresponding HARQ feedback enabled or disabled.

In a further embodiment, the association of the scheduled TB(s) and the HARQ process number(s) is determined by an indicated HARQ process number in the control signal and the corresponding HARQ processes with HARQ feedback enabled or disabled.

In some embodiment, the processor is further configured to terminate monitoring a search space for another control signal in a period after receiving the scheduled transport block(s), the period is determined by at least one of: the scheduled transport block(s) corresponding HARQ process with HARQ feedback enabled or disabled, the RNTI type associated with the control signal CRC scrambling, and the search space type associated with the control signal.

Referring to FIG. 11, the gNB (i.e. base unit) includes a processor, a memory, and a transceiver. The processors implement a function, a process, and/or a method which are proposed in FIG. 10.

The base unit comprises a processor; and a transmitter coupled to the processor, wherein the processor is configured to transmit, via the transmitter, HARQ configuration and a control signal scheduling transport block(s), where each of the scheduled transport block(s) is associated with an HARQ process number; and transmit, via the transmitter, the scheduled transport block(s) based on the control signal.

In some embodiment, the processor is further configured to determine HARQ feedback for each of the scheduled transport block(s) based on the associated HARQ process number and the HARQ configuration.

In one embodiment, the HARQ configuration indicates the HARQ processes with HARQ feedback enabled or disabled via bitmap manner.

In another embodiment, the HARQ configuration indicates the number of HARQ processes with HARQ feedback enabled or the number of HARQ processes with HARQ feedback disabled. Accordingly, the processor is further configured to determine the HARQ processes with HARQ feedback enabled and with HARQ feedback disabled according to the number of HARQ processes with HARQ feedback enabled or the number of HARQ processes with HARQ feedback disabled.

In yet another embodiment, the processor is configured to transmit, via the

transmitter, the scheduled transport block(s) with a transmission order determined by the HARQ process numbers and corresponding HARQ feedback enabled or disabled.

In a further embodiment, the association of the scheduled TB(s) and the HARQ process number(s) is determined by an indicated HARQ process number in the control signal and the corresponding HARQ processes with HARQ feedback enabled or disabled.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A user equipment (UE) for wireless communication, comprising:
at least one memory; and
at least one processor coupled with the at least one memory and configured to cause the UE to:
receive Hybrid Automatic Repeat request (HARQ) configuration and a control signal scheduling one or more transport blocks, wherein each of the scheduled one or more transport blocks is associated with a HARQ process number; and
receive the scheduled one or more transport blocks based on the control signal.

2. The UE of claim 1, wherein the at least one processor is further configured to cause the UE to:
determine HARQ feedback for each of the scheduled one or more transport blocks based on the associated HARQ process number and the HARQ configuration.

3. The UE of claim 1, wherein the HARQ configuration indicates HARQ processes with HARQ feedback enabled or disabled via a bitmap manner.

4. The UE of claim 1, wherein the HARQ configuration indicates a number of HARQ processes with HARQ feedback enabled or a number of HARQ processes with HARQ feedback disabled.

5. The UE of claim 4, wherein the at least one processor is further configured to cause the UE to determine HARQ processes with HARQ feedback enabled and with HARQ feedback disabled according to the number of HARQ processes with HARQ feedback enabled or the number of HARQ processes with HARQ feedback disabled.

6. The UE of claim 1, wherein the at least one processor is further configured to cause the UE to receive the scheduled one or more transport blocks with a transmission order determined by the HARQ process numbers and corresponding HARQ feedback enabled or disabled.

7. The UE of claim 1, wherein the association of the scheduled one or more transport blocks and the one or more HARQ process numbers is determined by an indicated HARQ process number in the control signal and corresponding HARQ processes with HARQ feedback enabled or disabled.

8. The UE of claim 1, wherein the at least one processor is further configured to cause the UE to terminate monitoring a search space for another control signal in a period after receiving the scheduled one or more transport blocks, and the period is determined by at least one of:
the scheduled one or more transport blocks corresponding HARQ process with HARQ feedback enabled or disabled,
a Radio Network Temporary Identity (RNTI) type associated with control signal Cyclic Redundancy Check (CRC) scrambling, and
a search space type associated with the control signal.

9. A method performed by a user equipment (UE), the method comprising:
receiving Hybrid Automatic Repeat request (HARQ) configuration and a control signal scheduling one or more transport blocks, where each of the scheduled one or more transport blocks is associated with a HARQ process number; and
receiving the scheduled transport blocks based on the control signal.

10. The method of claim 9, further comprising:
determining HARQ feedback for each of the scheduled one or more transport blocks based on the associated HARQ process number and the HARQ configuration.

11. The method of claim 9, wherein, the HARQ configuration indicates a number of HARQ processes with HARQ feedback enabled or a number of HARQ processes with HARQ feedback disabled.

12. (canceled)

13. (canceled)

14. (canceled)

15. A base station for wireless communication, comprising:
at least one memory; and
at least one processor coupled with the at least one memory and configured to cause the base station to:
transmit Hybrid Automatic Repeat request (HARQ) configuration and a control signal scheduling one or more transport blocks, where each of the scheduled one or more transport blocks is associated with a HARQ process number; and
transmit the scheduled one or more transport blocks based on the control signal.

16. A processor for wireless communication, comprising:
at least one controller coupled with at least one memory and configured to cause the processor to:
receive Hybrid Automatic Repeat request (HARQ) configuration and a control signal scheduling one or more transport blocks, wherein each of the scheduled one or more transport blocks is associated with a HARQ process number; and
receive the scheduled one or more transport blocks based on the control signal.

17. The processor of claim 16, wherein the at least one controller is further configured to cause the processor to:
determine HARQ feedback for each of the scheduled one or more transport blocks based on the associated HARQ process number and the HARQ configuration.

18. The processor of claim 16, wherein the HARQ configuration indicates HARQ processes with HARQ feedback enabled or disabled via a bitmap manner.

19. The processor of claim 16, wherein the HARQ configuration indicates a number of HARQ processes with HARQ feedback enabled or a number of HARQ processes with HARQ feedback disabled.

20. The processor of claim 19, wherein the at least one controller is further configured to cause the processor to determine HARQ processes with HARQ feedback enabled and with HARQ feedback disabled according to the number of HARQ processes with HARQ feedback enabled or the number of HARQ processes with HARQ feedback disabled.

21. The processor of claim 16, wherein the at least one controller is further configured to cause the processor to receive the scheduled one or more transport blocks with a transmission order determined by the HARQ process numbers and corresponding HARQ feedback enabled or disabled.

22. The processor of claim 16, wherein the association of the scheduled one or more transport blocks and the one or more HARQ process numbers is determined by an indicated HARQ process number in the control signal and corresponding HARQ processes with HARQ feedback enabled or disabled.

23. The processor of claim 16, wherein the at least one controller is further configured to cause the processor to terminate monitoring a search space for another control signal in a period after receiving the scheduled one or more transport blocks, and the period is determined by at least one of:
the scheduled one or more transport blocks corresponding HARQ process with HARQ feedback enabled or disabled,
a Radio Network Temporary Identity (RNTI) type associated with control signal Cyclic Redundancy Check (CRC) scrambling, and
a search space type associated with the control signal.
